(19) United States
(12) Patent Application Publication
(10) Pub. No.: US 2025/0304423 A1
(43) Pub. Date: Oct. 2, 2025

(54) ANYSIZE AUTOFILL WITH MACHINE LEARNING

(71) Applicant: WHIRLPOOL CORPORATION, Benton Harbor, MI (US)

(72) Inventors: Alison W. Pereira, Saint Joseph, MI (US); Arthur A. Marcon, Saint Joseph, MI (US); Luiz Henrique Tormen Longo, Joinville (BR); Matthias Freiherr von Andrian, Saint Joseph, MI (US)

(21) Appl. No.: 19/079,049

(22) Filed: Mar. 13, 2025

Related U.S. Application Data
(60) Provisional application No. 63/570,378, filed on Mar. 27, 2024.

(51) Int. Cl. B67D 1/08; B67D 1/00; F25C 5/20

(52) U.S. Cl. CPC B67D 1/0888; B67D 1/0014; F25C 5/22; F25C 2600/04

(57) ABSTRACT

A beverage dispensing system for an appliance may include a dispenser area defined within the appliance having a shelf configured to receive a container; a dispenser configured to release liquid into the container in the dispenser area; at least one sensor configured to detect a location of the container within the dispenser area; a user interface configured to display feedback to a user; and a controller configured to receive sensor data, determine whether the container is centered within the dispenser area based on the sensor data, and after a predefined waiting period, instruct the dispenser to dispense liquid to fill the container.

### CROSS-REFERENCED TO RELATED APPLICATION

This application claims the benefit of U.S. provisional application Ser. No. 63/570,378 filed Mar. 27, 2024, the disclosure of which is hereby incorporated in its entirety by reference herein.

### TECHNICAL FIELD

Disclosed herein are autofill systems and methods for appliance water and ice dispensing.

### BACKGROUND

Many modern appliances, such as refrigerators, feature water and ice dispensers designed to fill various containers, including cups, pitchers, and water bottles. Dispensers often operate at slower speeds to minimize splashing or dispense more quickly at the risk of spillage. Additionally, filling larger containers can be time-consuming and challenging due to size constraints within the dispenser cavity.

### SUMMARY

A beverage dispensing system for an appliance, may include a dispenser area defined within the appliance having a shelf configured to receive a container, a dispenser configured to release liquid into the container in the dispenser area, at least one sensor configured to detect a location of the container within the dispenser area, a user interface configured to display feedback to a user, and a controller configured to receive sensor data, determine whether the container is centered within the dispenser area based on the sensor data, and after a predefined waiting period, instruct the dispenser to dispense liquid to fill the container.

In one example, the controller is further configured to instruct the user interface to present a message during the waiting period, the message including information that the waiting period is occurring.

In another example, the sensor is further configured to detect whether a hand is within the dispenser area.

In one embodiment, the controller is further configured to determine whether the sensor data indicates occurrence of a stop condition, the stop condition including at least one of the container not being centered, the container being full, and the hand entering the dispenser area.

In another embodiment, the controller is further configured to instruct the dispenser to cease dispensing in response to the sensor data indicating a stop condition.

In one example, the system includes a light assembly arranged along at least one side of the dispenser area; wherein the controller is further configured to, in response to the container not being centered, instruct the feedback component to illuminate based on the container location to provide feedback to the user to facilitate correction of the container location.

In another example, the sensor is a light sensor configured to capture images of the dispensing area and wherein determining whether the container is centered within the dispenser area includes comparing the images with a baseline image; and wherein the controller is further configured to determine, based on the comparison, whether a container is present within the dispenser area.

In one embodiment, in response to determining that the container is present, the controller is further configured to identify a location of a rim of the container.

In another embodiment, the controller is further configured to determine whether a container is present includes comparing brightness levels of a pixel of the images.

A beverage dispensing system for an appliance may include a dispenser area defined within the appliance to receive a container, a dispenser configured to release ice into the container in the dispenser area, at least one camera configured to acquire images of the dispenser area, a controller configured to receive images from the camera, compare the images with saved images, determine a position of the container within the dispenser area, and initiate a dispense mode based on the position.

In one example, the system includes a user interface in communication with the controller and wherein the mode is an ice mode and the controller is configured to instruct the user interface to display an indication of the ice mode.

In another example, the dispenser is an ice dispenser and further comprising a water dispenser configured to release water into the container in the dispenser area, and wherein the controller is further configured to initiate at least one of ice mode and water mode depending on the container position relative to the ice dispenser.

In one embodiment, the controller is further configured to instruct the water dispenser to not dispense water during the ice mode.

In another embodiment, the camera is an infrared sensor arranged between an ice dispenser and a water dispenser.

A beverage dispensing system for an appliance may include a dispenser area defined within the appliance having a shelf configured to receive a container, a dispenser configured to release liquid into the container in the dispenser area, at least one sensor configured to detect whether a user's hand is within the dispenser area, a user interface configured to display feedback to a user, and a controller configured to receive sensor data, determine that the user's hand is within the dispenser area, and instruct the dispenser to cease dispensing in response to the sensor data indicating a stop condition.

In one example, the sensor is further configured to detect a location of the container within the dispenser area via images.

In another example, the controller is further configured to determine whether the container is centered within the dispenser area based on the sensor data; and after a predefined waiting period, instruct the dispenser to dispense liquid to fill the container.

In one embodiment, the controller is further configured to instruct the user interface to present a message during the waiting period, the message including information that the waiting period is occurring.

In another embodiment, the determining whether the container is centered within the dispenser area includes comparing the images with a baseline image; and the controller is configured to determine, based on the comparison, whether a container is present within the dispenser area.

In one example, the system includes a light assembly arranged along at least one side of the dispenser area; wherein the controller is further configured to in response to the container not being centered, instruct the feedback component to illuminate based on the container location to provide feedback to the user to facilitate correction of the container location.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a front view of a beverage dispensing system.

FIG. 2 illustrates a block diagram of components of the beverage dispensing system of FIG. 1.

FIG. 3 illustrates an example process for determining whether the container is centered within the dispensing area.

FIG. 4 illustrates a cross-sectional view of the dispenser area of the dispensing system, including the dispenser and the sensor.

FIGS. 5A-5C illustrate top-view images of an example container at various fill levels.

FIG. 6 illustrates a series of images from the infrared sensor.

FIG. 7 illustrates an example process for determining whether the container is centered within the dispensing area as well as if a user's hand is within the dispensing area.

FIG. 8 illustrates a matrix where each square in the representation represents the gray scale of the top view image by the infrared camera.

FIGS. 9A and 9B illustrate two matrices where FIG. 9A illustrates an empty dispenser area and FIG. 9B illustrates a container in the dispenser area.

FIG. 10A illustrates a container that is not centralized; and FIG. 10B illustrates a container that is centralized.

FIGS. 11A-D illustrate example images captured by the infrared camera.

FIG. 12 illustrates a schematic view of an example water line system for the dispensing system of FIG. 1.

FIG. 13 illustrates schematic view of an example water line system for the dispensing system of FIG. 1.

FIG. 14 illustrates a front view of a beverage dispensing system having at least one feedback component.

FIG. 15A illustrates an example user interface for the dispenser system of FIG. 1.

FIG. 15B illustrates another example user interface for the dispenser system of FIG. 1.

FIG. 16 illustrates a top view of an example dispenser having an ice dispenser and a water dispenser.

FIGS. 17A and 17B illustrate front view of the dispensing system, including an example where the container is close to the dispenser and another where the container rests on the shelf.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Many appliances, such as refrigerators, include water and ice dispensers that dispense water and ice to containers such as cups, pitchers, water bottles, etc. Current dispensers may dispense slowly to avoid splashing, or dispense faster and risk the splashing. Further, larger containers or vessels may take longer to fill and may be difficult to fit within the cavity of the dispenser. Typically, auto fill options may include a camera to acquire images and determine a position and height of the cup in the dispenser. However, existing solutions do not detect if a container is in the correct position and do not automatically fill up the container while a consumer is holding the container. Feedback as to the status and guides to help the consumer with accurate placement may also be desired.

Disclosed herein are various systems that allow consumers to automatically fill a container of any size, without interacting with the appliance. This may include centralizing the container. Once the container is centralized, the system may automatically dispense ice or water. In some example, once the container is centralized, a timer may start and, if more than a predetermined amount of time has passed, water may start dispensing. In conjunction with this, a corresponding message on a user interface may also be presented.

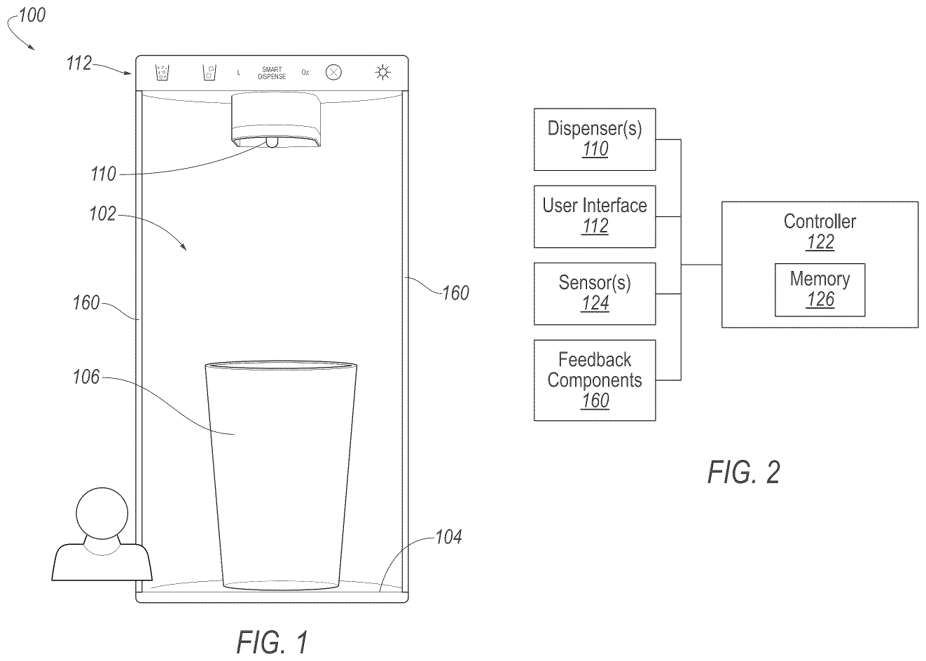

FIG. 1 illustrates a front view of a beverage dispensing system 100. The system 100 may include a dispenser area 102 receded and defined in an appliance. In one example, the appliance may be a refrigerator, but other appliances may also be considered, such as ice makers. The dispenser area 102 may be configured to receive a container 106 configured to hold liquids. This container may be of various sizes and shapes and may be a drinking class, cup, coffee mug, pitcher, vase, tumbler, etc. The dispenser area 102 may be large enough to accommodate various sizes and shapes of containers. The dispenser area 102 may include a shelf 104 at the bottom thereof to allow the container 106 to rest thereon.

The system 100 may include at least one dispenser 110. The dispenser 110 may be a spout configured to dispense water from the appliance. A second dispenser (not shown in FIG. 1) may be configured to dispense ice from the appliance. Each of these may be arranged at or near the top of the dispenser area 102 above the shelf 104. The system 100 may include at least one user interface 112 configured to receive user commands, as well as display information to the user. Feedback components 160 are arranged on each side of the dispenser area 102. These components are described in more detail herein.

FIG. 2 illustrates a block diagram of components of the beverage dispensing system 100 of FIG. 1. The system 100 may include a controller 122 or processor configured to control the dispensing of the system 100.

The controller 122 may include the machine controller and any additional controllers provided for controlling any of the components of the system 100. Many known types of controllers can be used for the controller. It is contemplated that the controller is a microprocessor-based controller that implements control software and sends/receives one or more electrical signals to/from each of the various working components to implement the control software.

The controller 122 may also include or be coupled to a memory 126 configured to include instructions and databases to carry out the systems and processes disclosed herein. The memory 126 may maintain data, images, etc., used to determine the location of the container 106 when compared to sensor data.

The system 100 may include at least one sensor 124 configured to detect the location of the container 106 relative to the dispenser area 102. The sensors may be used to determine the location of the container, such as the height of the container 106, as well as the lateral location to determine whether the container 106 is centered or not.

In one example, the sensor 124 may be a time of flight (ToF) sensor, ultrasonic sensor, camera, such as an infrared camera, etc. In the example of an ultrasonic sensor, a sensor may be selected to have a range to encompass the dispenser area and may also be waterproof. In one example, the sensor may be a camera used to determine the left to right and front to back location of the container 106. In another example, images from an infrared camera may be used to compare to previously collected images or data to determine a fill level.

The controller 122 may communicate with the at least one user interface 112 to provide instructions for display, as well as to receive user input at the interface 112. The user interface 112 may present information to the user to inform the user of a status, mode, etc. In one example, the user interface may provide a waiting time to the user indicating the time left to a fill level. The user interface 112 may also indicate a message regarding centralization, including an indication the container is centralized, as well as information to guide the user to adjust the container position, e.g., “move container to the left,” etc. During the filling period the user interface 112 may also indicate that the container is being filled, in addition to or in alternative to the wait time. The user interface 112 may also indicate when a fill is completed. Other information regarding fill and mode status' may also be contemplated.

The controller 122 may also communicate with a feedback component 160 to provide feedback to the user regarding the placement of the container 106 within the dispensing area 102.

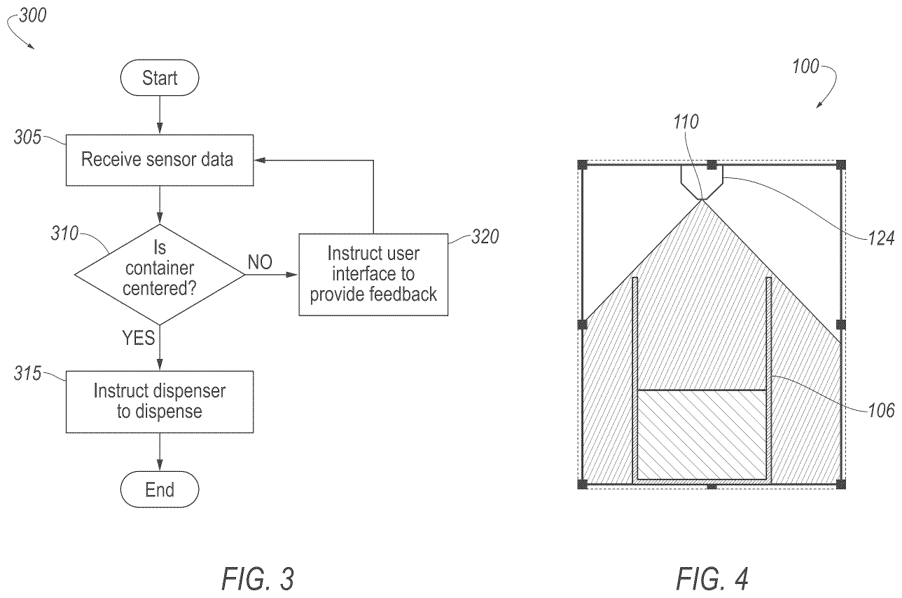

FIG. 3 illustrates an example process 300 for determining whether the container 106 is centered within the dispensing area 102. The process 300 begins at block 305 where the controller 122 receives sensor data from the at least one sensor 124. The sensor data may include location data of the container 106, including lateral and/or vertical placement.

At block 310, the controller 122 may determine whether the container 106 is centered based on the sensor data. If so, the process 300 may proceed to block 320. If not, the process 300 may proceed to block 320.

At block 315, the controller 122 may instruct the dispenser 110 to dispense after a predefined waiting period. The predefined waiting period may be, in one example, three seconds. Concurrently, the user interface 112 to display a sensing message to be displayed during the predefined waiting period. The message may indicate that the predefined waiting period is occurring. Such feedback may increase user satisfaction and avoid uncertainty as to the system's working order.

At block 320, in response to the controller 122 determining that the container is not centralized withing the dispensing area 102, the controller 122 may instruct the user interface 112 to provide feedback to the user about the lack of centralization. For example, the user interface 112 may instruct the user to move the container 106 a certain direction, etc., or simply indicate that the container 106 will not fill until centralized.

Additionally or alternatively, addition steps and verifications may be performed. In one example, the sensor data may also indicate the fill level of the container 106 in that that the controller 122 may be used the sensor data to determine whether the container 106 is empty prior to dispensing. If considered empty, the process 300 may proceed to block 310 to determine whether the container 106 is centered.

FIG. 4 illustrates a cross-sectional view of the dispenser area 102 of the dispensing system 100, including the dispenser 110 and the sensor 124. In this example, the sensor 124 may be an infrared camera having a lower resolution (e.g., 1600 pixels, 40×40). The sensor 124 may be configured to acquire a top-view of the container 106. The infrared camera may output the low resolution matrix where each pixel represents a gray level (which varies from 0 to 255) corresponding to the light intensity that returns to the sensor. Additionally or alternatively, a sensor 124 may include a second ultrasonic sensor. The ultrasonic sensor may function as a distance sensor, fill level sensor, etc., as described herein.

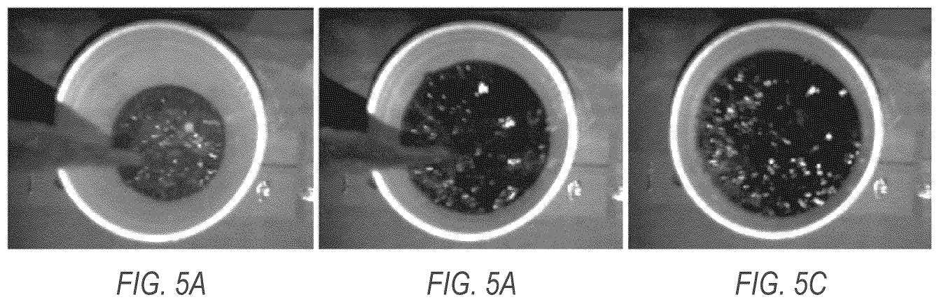

FIGS. 5A-5C illustrate top-view images of an example container 106 at various fill levels. The sensor 124 may be configured to classify these images based on the different infrared frames. Such classification may include being one of a close solenoid, or an open solenoid. Images that may result in a close solenoid classification, may include images that show a cup not centralized with a hand holding it; a cup not centralized without any hand holding it; a cup centralized and a hand not holding it; a cup full; or a dispenser being empty. On the other hand, images that may result in an open solenoid classification may include images that show a cup centralized, empty, and without a hand holding it; a cup centralized empty, and with a hand holding it; a cup centralized, half-full, and without a hand holding it; and a cup centralized, half-full, and with a hand holding it. Thus, an open solenoid classification results when the container 106 is not centered. Such images may be used to train a machine learning algorithm. The controller 122 may add noise to each frame to better train the algorithm.

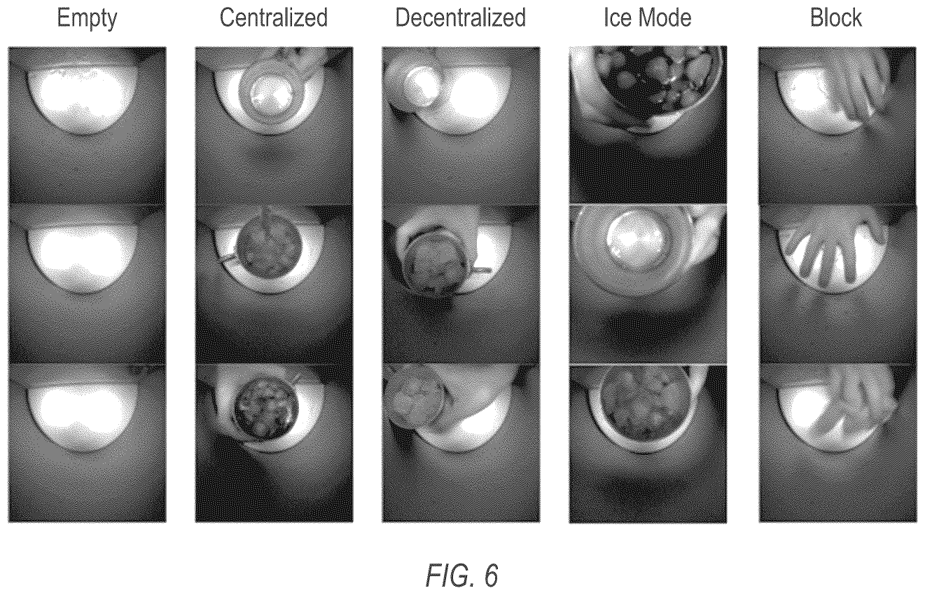

FIG. 6 illustrates a series of images from the infrared sensor. In addition to determining a fill level, the controller 122 is configured to determine the container location within the dispensing area 102, as well as the position of a user's hand relative to the cup. In addition to accounting for noise, machine learning techniques may be used to classify an images such as “Centralized”, “Left”, “Right”, “Block/Hand”, “Ice Mode” and “Empty.”

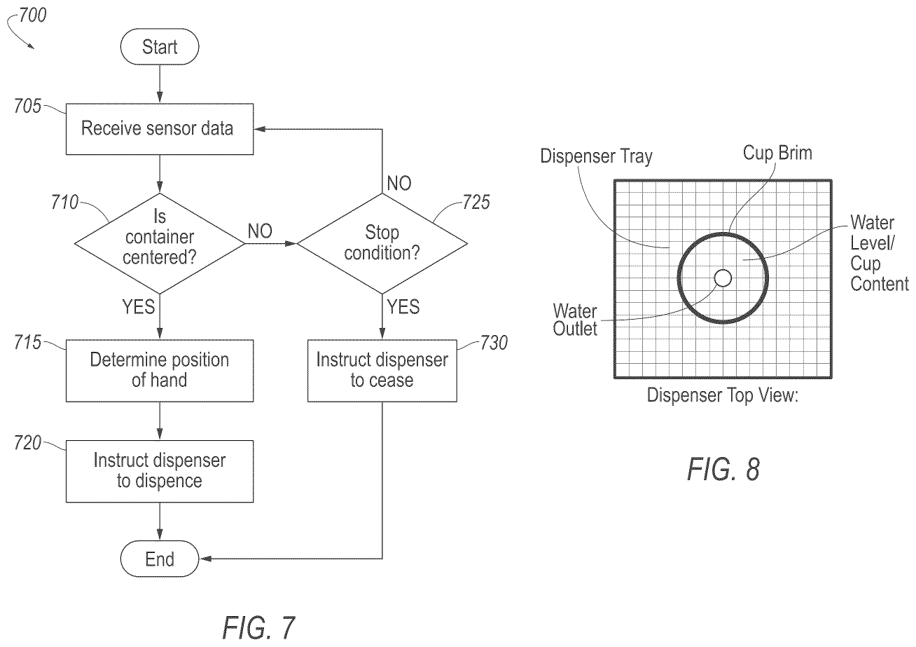

FIG. 7 illustrates an example process 700 for determining whether the container 106 is centered within the dispensing area 102 as well as if a user's hand is within the dispensing area 102. The process 700 begins at block 705 where the controller 122 receives sensor data from the at least one sensor 124. The sensor data may be images from the infrared camera.

At block 710, the controller 122 may determine whether the container 106 is centered based on the sensor data. If so, the process 700 may proceed to block 715. If not, the process 700 may proceed to block 725.

At block 715, the controller 122 may determine a position of the user's hand relative to the container 106. As explained, this may be done by comparing and evaluating the frames from the infrared camera.

At block 720, the controller 122 may instruct the dispenser 110 to dispense liquid.

At block 725, the controller 122 may determine whether a stop condition exists based on the sensor data. A stop condition may include the cup not being centered, the cup being full, or a hand entering the dispenser area. The controller 122 may also concurrently instruct the user interface 112 to instruct the user as to why the dispenser stopped dispensing to provide valuable feedback to the user. Such safeguards may prevent children from auto-starting a dispensing.

The process 700 may then end.

In addition to using the IR frames to determine whether the container 106 is centralized or if there is a hand in the way, the controller 122 may be configured to determine a height of the container 106 based on the IR frames. The IR frames may be applied with machine learning to determine the container height. The fill level may be determined by comparing new IR frames with previous ones (see e.g., FIGS. 5A-C). While the container 106 is being filled, the interior fills with water and the cup interior gets darker with time until there is a certain level of darkness that correlates to that cup being full. For ice mode detection, the camera may identify if the container 106 is close to the ice dispenser without needed to know its exact location.

Referring back to FIG. 4, the sensor 124 may include two sensors. In one example, the first sensor may be an infrared camera, and the second sensor may be an ultrasonic sensor. The infrared camera, as explained above, may be configured to acquire a top-view of the container 106. The infrared camera may output the low resolution matrix where each pixel represents a gray level (which varies from 0 to 255) corresponding to the light intensity that returns to the sensor. The brim and cup content occupy the space where the pixel information is different to the baseline. The baseline is that of an empty dispenser area.

FIG. 8 illustrates a matrix where each square in the representation represents the gray scale of the top view image by the infrared camera. The controller 122 continues to continuously analyze and verify images from the camera to determine if any pixel is different from the baseline.

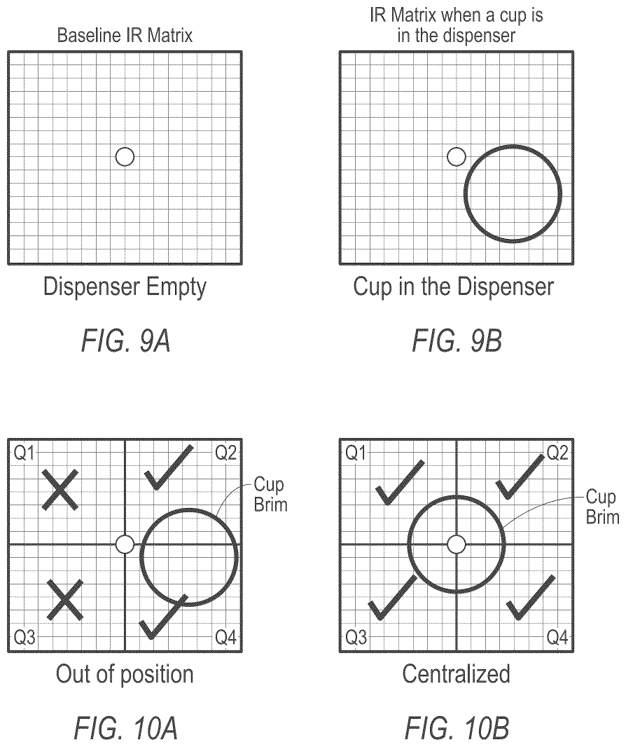

FIGS. 9A and 9B illustrate two matrices where FIG. 9A illustrates an empty dispenser area 102 and FIG. 9B, by comparison, illustrates a container 106 in the dispenser area 102.

Upon recognizing a container, or anything other than a baseline, the controller 122 will then determine whether a brim of the container 106 is identified, as well as if the container 106 is centralized.

FIG. 10A illustrates a container 106 that is not centralized, and FIG. 10B illustrates a container 106 that is centralized. This determination is completed in near real-time and does not require the user to wait during the auto-fill process. The determination is also made based on calculations of comparing the current pixel value with the baseline value and may not require machine learning. The algorithm may walk through the 160mx matrix from the right to the left and left to right, searching for the first pixel that differs from the baseline. Once this pixel is found, it is understood that the brim is placed in that area. The controller 122 may also identify liquid within the brim based on the brightness level.

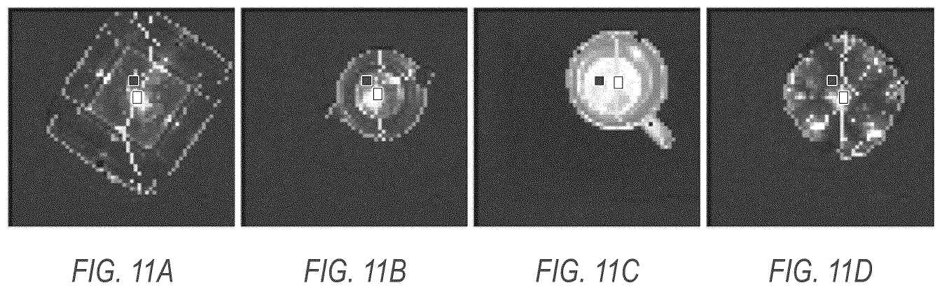

FIGS. 11A-D illustrate example images captured by the infrared camera. The dots may represent various contours and outlines of the container as acquired after image processing. For example, certain dot colors may represent certain image attributes such as cup contours, brim locations, etc. Specifically, in FIGS. 11A-D, smaller dots may represent the contour, the larger dot represents where water will fall once dispense, and the largest dot represents the identified center of the cup.

The controller 122 determines whether the cup is centralized or not. Such information, as discussed above with respect to FIG. 3, may automatically initiate dispensing at the dispenser 110. The second sensor may be an ultrasonic sensor configured to determine a liquid level within the container 106.

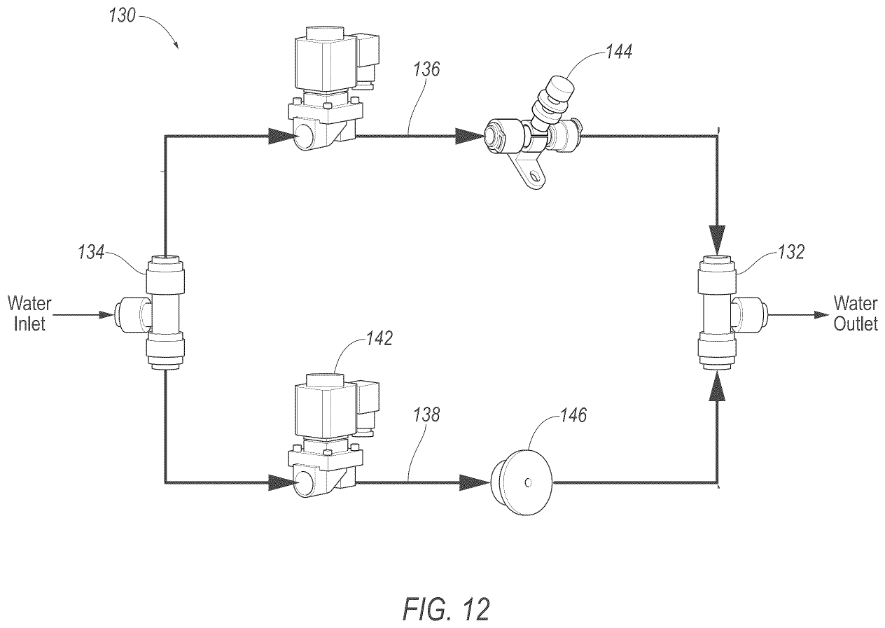

FIG. 12 illustrates a schematic view of an example water line system 130 for the dispensing system 100 of FIG. 1. The system 130 includes a water outlet 132 (also referred to herein as a water dispenser or water spigot) configured to release water to the container 106. The system 130 includes a water inlet 134 configured as a two-way divider and dividing the water flow into a first path 136 and a second path 138. A first solenoid valve 140 is arranged on the first path 136 and a second solenoid valve 142 is arranged on the second path 138. In series with the first solenoid valve 140 is a calibrated pressure restrictor 144. In series with the second solenoid valve 142 is a fixed pressure restrictor 146. The first path 136 and the second path 138 enter into a two-way divider at the water outlet 132. The water outlet 132 may be a spigot with a 16 mm internal diameter allowing for an increase in volumetric flow rate without increasing the relative speed at the water outlet line, which reduces the momentum when the water touches the bottom of the cup and eliminates splashes.

The controller 122 may open the bottom solenoid valve 142 when the system is activated (e.g., instructed to dispense). The second path 138 will feed water to the water outlet at a slow pressure, and therefore lower volumetric water flow. After a predefined amount of time, the controller 122 instructs the first solenoid valve 140 to open. The flow at the first path 136 is much higher than that at the second path 138 due to the calibrated restrictor 144 on the first path and the fixed restrictor 148 on the second path. The dispensing may start off slower, assuming that the container 106 is empty and therefore, more likely to create a splash on an empty surface at the bottom of the container 106. After the predefined amount of time (e.g., four seconds), the container 106 may be partially filled, creating a dampening of the flow within the container 106. Thus, because of the water already in the container 106, a splash typically created by a higher force stream is no longer of concern. The first path 136 may thus release water at the higher rate after the predefined amount of time.

Once the dispensing is near complete, the first solenoid valve 140 may again close to allow the dispenser 110 to finish dispensing at the slower rate. Accordingly, the controller 122 is configured to instruct the second solenoid valve 142 to open and the first solenoid valve 140 to close to deliver water to the container 106 at a first flow rate, and in response to the first time expiring, open the second solenoid valve 142 to deliver water at a higher second flow rate. The controller 122 is also configured to instruct the second solenoid valve 142 to close in response to a second time expiring to return to delivering the water at the first flow rate.

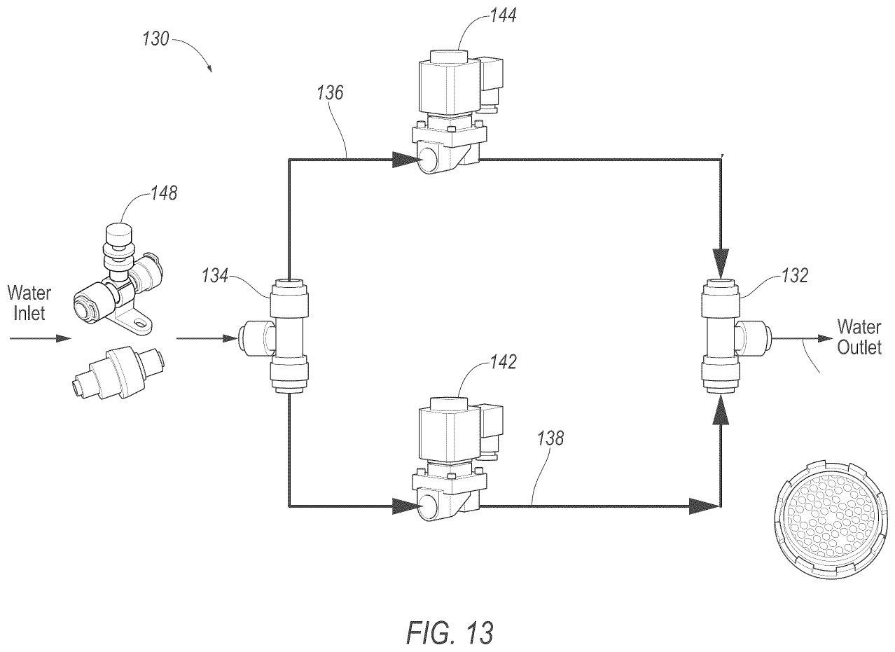

FIG. 13 illustrates schematic view of an example water line system 145 for the dispensing system 100 of FIG. 1. The system 145 may be similar to system 130 described in FIG. 12 except without the calibrated pressure restrictor 144 and fixed pressure restrictor 146. Prior to the water inlet 134, the system 145 may include a pressure limiting component 148. Similar to the above, the controller 122 is configured to instruct the second solenoid valve 142 to open and the first solenoid valve 140 to close to deliver water to the container 106 at a first flow rate, and in response to the first time expiring, open the second solenoid valve 142 to deliver water at a higher second flow rate. The controller 122 is also configured to instruct the second solenoid valve 142 to close in response to a second time expiring to return to delivering the water at the first flow rate.

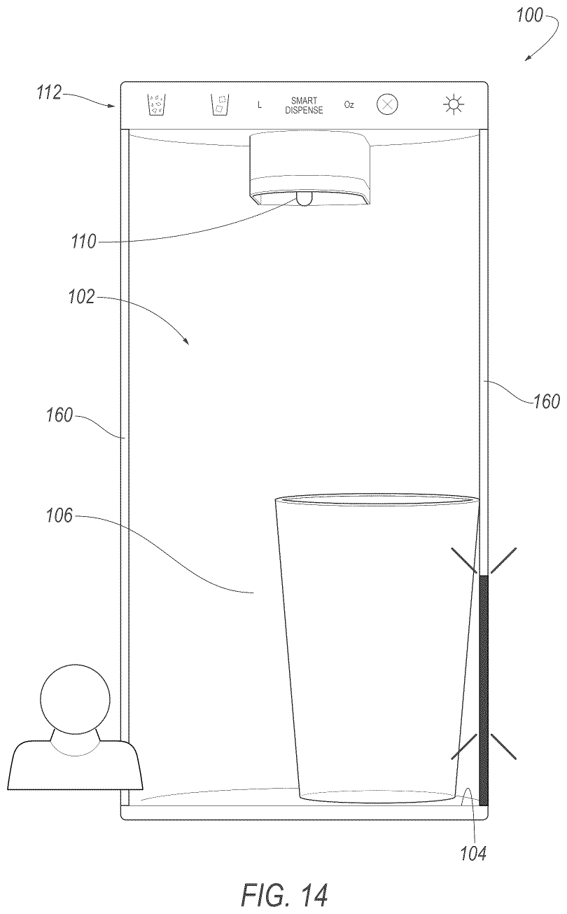

FIG. 14 illustrates a front view of a beverage dispensing system 100 having at least one feedback component 160. In one example, the feedback component 160 may be a light assembly such as a light strip arranged along the side of the dispenser area 102. The strip may be an LED strip, configured to illuminate in response to a detected location of the container 106. The location of the container 106 may be determined based on any of the systems and methods described herein.

The feedback component 160 may illuminate according to the location to provide feedback and guidance to the user about the location of the container 106. For example, when a container 106 is placed in the dispenser area, the strips may turn on with white color at full brightness with a fade-in effect. If the container 106 is placed in the wrong position, one side of the strip may become orange and start blinking, as illustrated in FIG. 14.

When the container 106 is positioned in a correct position, the orange light may stop blinking and turn white again. When the system begins to dispense water, the strip may continue to be while. If the container 106 is not compatible with the system 100, both strips may blink, either in white color or in another color such as orange. The strips may also be animated to have a waterfall effect while the dispenser fills the container 106.

Other display options and animations may be included, such as other colors, etc. The display strips may also be customizable by the user. The controller 122 may instruct the strip based on the container location 106. In response to detecting the container 106 is not centered, the controller 122 may instruct that a portion of one side illuminate and/or blink a different color, as shown in FIG. 14. This may alert the user to the fact that the container 106 is too far to one side. When the container 106 is centered, the strips may illuminate white, or even green, to indicate to the user that the container 106 is properly placed. Such feedback helps with user satisfaction and confidence.

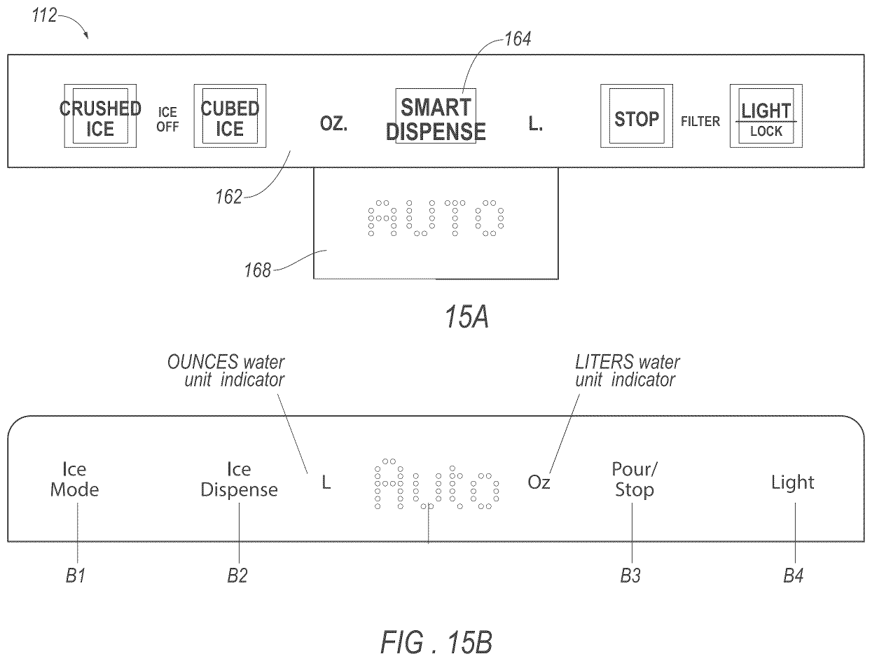

FIG. 15A illustrates an example user interface 112 for the dispenser system 100 of FIG. 1. The user interface 112 may include a top panel 162 having a plurality of buttons. In this example, four buttons, one for each of the ice select, crushed or cubed, a stop button and light button. A central display 164 may indicate a mode to the user, such as “smart dispense.”

A dot matrix display 168 may be arranged below the top panel and may be configured to scroll messages. The dot matrix display 168 may be arranged over the dispenser 110. In another example, the dot matrix 168 may be integrated into the top panel 162. The user interface 112 may be controlled and in communication with the controller 122 to receive user commands as well as display information to the user.

FIG. 15B illustrates another example of a user interface for the dispenser system of FIG. 1 including a Smart Dispense button.

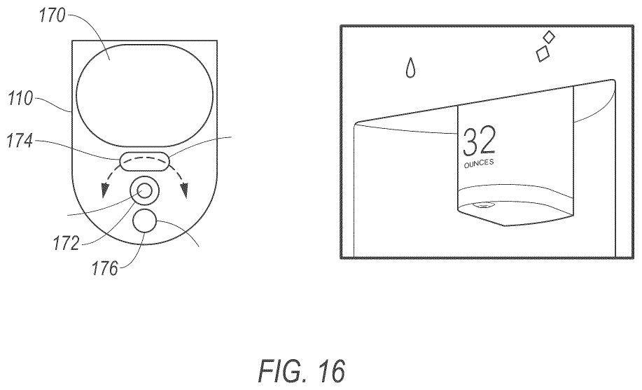

FIG. 16 illustrates a top view of an example dispenser 110 having an ice dispenser 170 and a water dispenser 172. Sensors 124 may be included at or near the dispenser such as an ultrasonic sensor 174 and an infrared sensor 176. However, some systems 100 may require only one of these sensors. As explained above, the infrared sensor 176 may be a camera configured to acquire images and may be configured to pick up light intensity. The infrared sensor 176 may be placed right in front of the nozzle to allow the detection of a hand entering the dispenser.

In this example, the infrared sensor 176 may have a lower resolution light intensity sensor output of a 4900px matrix, where each pixel represents a light level between 0 to 255. The controller 122 may determine, based on this data, whether a container is present, if the container 106 is centralized, and if there is any movement that should prevent water dispensing.

At every step where new sensor data is available, the controller 122 may compare the current light intensity matrix to a dataset of previously labeled light intensity matrices corresponding to scenarios of empty dispensers, centralized containers, etc. The controller 122 will then determine to which of the classes of the new sensor data is more similar to and make a determination.

For example, to determine if the container 106 or hand is stationary, the controller 122 compares the current light intensity matrix to one from a previous timestamp. If fewer than a predefined number of pixels are different, the algorithm determines that the object is standing still, otherwise the algorithm determines that the object is moving. To determine if the container 106 is centralized, the controller 122 may compare to known centralized light intensity matrices.

The controller 122 may also determine a relative height of the container 106 within the dispensing area 102. Such height may be used to automatically select a mode, such as an ‘ice mode’ or ‘water mode’. For the first “ice mode” detection concept, the camera compares images to the dataset and checks a degree of similarity between new images and previous images from the dataset that were labeled as “ice mode”. For a frame to be characterized as “Ice Mode”, the frame may contain a picture of a hand holding a cup that occupies most of the frame, which, by correlation, represents a case where someone is holding a cup close to the ice chute. Further, during the ice mode, the controller 122 may “block” the water dispenser from dispensing water. The converse may also exist where during the water mode, the controller 122 may block ice from dispensing from the ice dispenser. The dispenser 110 may refer to both an ice and water dispenser, but each may also be separate dispensers.

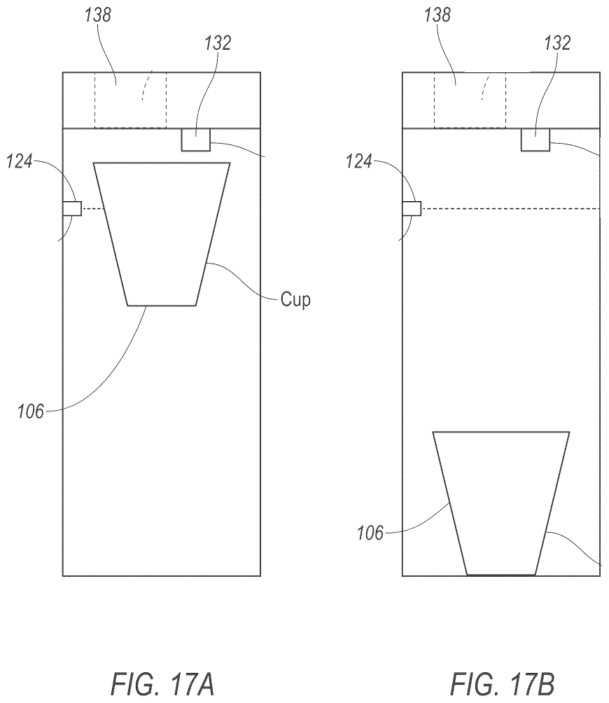

FIGS. 17A and 17B illustrate front view of the dispensing system 100, including an example where the container 106 is close to the dispenser 110 and another where the container 106 rests on the shelf 104. As explained, the dispenser 110 may collectively include an ice dispenser or ice chute 138 and a water dispenser or water spigot 132. If the container 106 is close to the dispensers 110, or above a threshold height, the controller 122 may recognize this and enter into ice mode. The controller 122 may instruct the user interface 112 to display such mode. An ice button on a top panel may also light up in response to such determination and the dispenser 110 may automatically start to dispense ice. Ice may be dispensed until the rim of the container 106 is moved.

The distance sensor represented by FIG. 17 may additionally or alternatively be used for triggering an ice mode. This sensor will allow not only “ice mode” detection, but also cause trigger an automatic ice release while the cup is held in front of this sensor. This distance sensor may be a ToF, IR sensor, or a US sensor, that measures the travel time of light or ultrasound waves to determine how far an obstacle is. The distance sensor

may automatically trigger the ice release. In the case where an IR camera is used to identify the position of the cup relative to the ice chute, the lighting in the user interface may be triggered to present the option for the user to select ice mode or initiate the ice release.

Notably, the system 100 may continuously monitor the dispenser area 102 via the sensor(s) and make any adjustments to the dispensing, user interface, etc., as deemed necessary. For example, if mid-fill, the controller 122 detects a hand, the controller 122 may instruct the dispenser 110 to cease dispensing. The controller 122 may also dynamically adjust a detected rim location to prevent overflows and spills and increase user satisfaction.

Accordingly, an automatic dispenser system is disclosed herein that allows for better user satisfaction, less splashing, less overspills, and with minimal additional components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A beverage dispensing system for an appliance, comprising:
a dispenser area defined within the appliance having a shelf configured to receive a container;
a dispenser configured to release liquid into the container in the dispenser area;
at least one sensor configured to detect a location of the container within the dispenser area;
a user interface configured to display feedback to a user; and
a controller configured to
receive sensor data;
determine whether the container is centered within the dispenser area based on the sensor data; and
after a predefined waiting period, instruct the dispenser to dispense liquid to fill the container.

2. The system of claim 1, wherein the controller is further configured to instruct the user interface to present a message during the waiting period, the message including information that the waiting period is occurring.

3. The system of claim 1, wherein the sensor is further configured to detect whether a hand is within the dispenser area.

4. The system of claim 3, wherein the controller is further configured to determine whether the sensor data indicates occurrence of a stop condition, the stop condition including at least one of the container not being centered, the container being full, and the hand entering the dispenser area.

5. The system of claim 4, wherein the controller is further configured to instruct the dispenser to cease dispensing in response to the sensor data indicating a stop condition.

6. The system of claim 1, further comprising a light assembly arranged along at least one side of the dispenser area; wherein the controller is further configured to, wherein the controller is further configured to, in response to the container not being centered, instruct the feedback component to illuminate based on the container location to provide feedback to the user to facilitate correction of the container location.

7. The system of claim 1, wherein the sensor is a light sensor configured to capture images of the dispensing area and wherein determining whether the container is centered within the dispenser area includes comparing the images with a baseline image; and determining, based on the comparison, whether a container is present within the dispenser area.

8. The system of claim 7, wherein in response to determining that the container is present, the controller is further configured to identify a location of a rim of the container.

9. The system of claim 7, wherein determining whether a container is present includes comparing brightness levels of a pixel of the images.

10. A beverage dispensing system for an appliance, comprising:
a dispenser area defined within the appliance to receive a container;
a dispenser configured to release ice into the container in the dispenser area;
at least one camera configured to acquire images of the dispenser area;
a controller configured to
receive images from the camera;
compare the images with saved images;
determine a position of the container within the dispenser area; and
initiate a dispense mode based on the position.

11. The system of claim 10, further comprising a user interface in communication with the controller and wherein the mode is an ice mode and the controller is configured to instruct the user interface to display an indication of the ice mode.

12. The system of claim 10, wherein the dispenser is an ice dispenser and further comprising a water dispenser configured to release water into the container in the dispenser area, and wherein the controller is further configured to initiate at least one of ice mode and water mode depending on the container position relative to the ice dispenser.

13. The system of claim 12, wherein the controller is further configured to instruct the water dispenser to not dispense water during the ice mode.

14. The system of claim 12, wherein the camera is an infrared sensor arranged between an ice dispenser and a water dispenser.

15. A beverage dispensing system for an appliance, comprising:
a dispenser area defined within the appliance having a shelf configured to receive a container;
a dispenser configured to release liquid into the container in the dispenser area;
at least one sensor configured to detect whether a user's hand is within the dispenser area;
a user interface configured to display feedback to a user; and
a controller configured to
receive sensor data;
determine that the user's hand is within the dispenser area; and
instruct the dispenser to cease dispensing in response to the sensor data indicating a stop condition.

16. The system of claim 15, wherein the sensor is further configured to detect a location of the container within the dispenser area via images.

17. The system of claim 16, wherein the controller is further configured to determine whether the container is centered within the dispenser area based on the sensor data; and after a predefined waiting period, instruct the dispenser to dispense liquid to fill the container.

18. The system of claim 17, wherein the controller is further configured to instruct the user interface to present a message during the waiting period, the message including information that the waiting period is occurring.

19. The system of claim 17, wherein determining whether the container is centered within the dispenser area includes comparing the images with a baseline image; and determining, based on the comparison, whether a container is present within the dispenser area.

20. The system of claim 17, further comprising a light assembly arranged along at least one side of the dispenser area; wherein the controller is further configured to in response to the container not being centered, instruct the feedback component to illuminate based on the container location to provide feedback to the user to facilitate correction of the container location.
